(19) United States
(12) Patent Application Publication
(10) Pub. No.: US 2015/0019352 A1
(43) Pub. Date: Jan. 15, 2015

(54) ON-PAGE MARKETPLACE BANNER ADVERTISING SYSTEM

(71) Applicant: Michael Flynn, Newtown, PA (US)

(72) Inventor: Michael Flynn, Newtown, PA (US)

(21) Appl. No.: 14/329,929

(22) Filed: Jul. 12, 2014

Related U.S. Application Data
(60) Provisional application No. 61/845,753, filed on Jul. 12, 2013.

(51) Int. Cl. G06Q 30/02; G06Q 20/10; G06F 17/30; G06F 3/0481; G06F 3/0484

(52) U.S. Cl. CPC G06Q 30/0277; G06F 3/04817; G06F 3/04842; G06F 17/30893; G06Q 20/10
USPC 705/14.73

(57) ABSTRACT

The example embodiment discloses a method of advertising including providing multiple icons from multiple merchants within a defined advertising space on a webpage, where each of the multiple icons corresponds to one of the multiple merchants. The example method also includes responding to a user's selection of one of the multiple icons by displaying an offer to purchase goods or services from one of the multiple merchants, where displaying the offer is performed within the defined advertising space on the webpage.

### CROSS REFERENCE TO RELATED APPLICATIONS

This application claims priority to a provisional application Ser. No. 61/845,753 Filed 12 Jul. 2013 titled: Interactive Online Advertising System, which is a pending application, the disclosure of which is incorporated herein by reference in its entirety including specification, claims, and drawings.

This application claims priority to a provisional application Ser. No. 61/986,175 Filed 30 Apr. 2014 titled INTERACTIVE ICONS FOR GRAPHIC USER INTERFACE, which is a pending application, the disclosure of which is incorporated herein by reference in its entirety including specification, claims, and drawings.

### TECHNICAL FIELD

The example embodiment is directed to web-based advertising. More specifically, the example embodiment provides an on-page banner advertising system having interactive icons and menus on a content provider's site that provides internet consumers with a more entertaining, personalized, and interactive online shopping experience.

### BACKGROUND

Electronic commerce refers to the activity of purchasing and selling products online. The shopping process often involves the aspect of a seller conveying certain information to a potential purchaser. As the popularity of online shopping has increased, users' expectations of increased interactivity to enhance their online experience has also increased. As consumers are constantly bombarded with information, the public's desire for fast and efficient information and shopping experience has increased. In addition, methods such as gaming, reward systems, and interactive media are used by online marketplaces to entice consumers. Websites that do not provide user interactivity beyond standard transactional menus are easily forgotten. Without extra forms of entertainment to draw in shoppers, online consumers will continue to surf the internet in search of interactive website that still provide them with desired goods and services.

Another challenge with online advertising, whether on traditional websites or on mobile devices, is the desire of a consumer to stay on the page where they are consuming content. For example, a consumer may search for a favorite topic, or go to a social media site seeking content and find an article, blog post, game site or other site that provides desired content. The consumer clicks on the link and goes to the page with the desired content. While on the page with the article, social media information, game or blog there are advertisements on the top and sides of the screen, and sometimes breaking the flow of the article or content. These advertisements are seeking to distract the consumer and get them to leave the page with the content they wanted. This also creates a challenge for the content provider, as they cannot provide content or additional advertising to the consumer once they leave the page.

There is a need for a system that allows consumers to receive information about advertised goods without navigating away from a content provider's website.

Consumers also increasingly shop via mobile devices. Online browsing can be done at any time and at any place without restriction. Consumers expect personalization including special deals. Therefore, there is a need in the shopping forum for a highly personalized online advertising and shopping system that provides online consumers with user-directed interactive means in a fast and efficient manner and offers purchases of products tailored for and desired by the consumer.

### SUMMARY

The disclosed method and system provides a highly personalized online advertising and shopping system that offers online consumers with advertisements through interactive games and other user-directed interactive means, as well as providing them with a fast, efficient way to purchase offered products. Further, an example embodiment allows a consumer to receive information about products and offers, and purchase those offers without leaving the content provider's website.

Users interact with the system's dynamic icons and other features. The disclosure includes the following components: 1) an online platform, composed of two key features: (a) the matrix, a platform managed by the host and/or administrator of the system of the disclosed method and system; and (b) the marketplace, hosted and/or administered on a content provider's site; and 2) game appification.

In an example embodiment a method of advertising includes the steps of providing multiple icons from multiple merchants within a defined advertising space on a webpage, where each of the multiple icons corresponds to one of the multiple merchants, and responding to a user's selection of one of the multiple icons by displaying an offer to purchase goods or services from one of the multiple merchants. The displaying of the offer is performed within the defined advertising space on the webpage. The example method may also include the step of collecting payment information within the defined advertising space on the webpage.

In another embodiment the example method includes the step of communicating information about at least one of the multiple merchants by adjusting visual aspects of at least one of the multiple icons. In one embodiment communication is performed by changing a color to indicate distance to at least one of the multiple merchants. The communication may also be performed by changing a color to indicate a rating of the at least one of the multiple merchants.

Payment information may be collected using an online payment system that allows for transfer of credits and debits electronically. Providing multiple icons may include providing the multiple icons aligned in rows and columns.

The example method may also include hosting an email account for the user where purchasing and shipping information from purchases made from the offer to purchase are sent to the email account. An example embodiment of the method includes tracking the user with a tracking cookie, where the offer to purchase goods or services is displayed according to information from the tracking cooking. The example method may also include tracking the user's interactions with the multiple icons and adjusting the multiple icons based on the user's interactions.

Responding to a user's selection may include providing information regarding liquidation sale items. Responding to a user's selection may also include providing information regarding products offered from a merchant corresponding to the user's selection of the one of the multiple icons.

### DETAILED DESCRIPTION

In an example embodiment the website and mobile application system include a collection of links representing content relating to various companies, brands, and advertisers. These links are represented graphically with an icon featuring the logo or some other symbol representing that advertiser. The icons are arranged on the main display screen in a grid-like arrangement “matrix.” When a user identifies an advertiser in which he or she is interested, the consumer hovers his or her cursor over the icon. If that advertiser has any special deals, sales, news, products, or other novel event, the icon will alert the user. Alerts can be communicated in a variety of ways, typically by the icon “glowing” as disclosed in U.S. Patent Application No. 61/986,175 titled INTERACTIVE ICONS FOR GRAPHIC USER INTERFACE, incorporated herein in its entirety by reference.

The icon of the example embodiment communicates information to the observer or user by displaying information in a manner disclosed herein. In an example embodiment, information is displayed or expressed by the icon “glowing” in order to indicate that certain information is intended to be communicated. As used herein, the term “glow” refers to giving off of light or radiance that emanates from the icon and is visually ascertainable and distinguishable on the display screen of the device. In addition, the “glow” as used herein, refers to various illustrative effects that emanate from the icon. In various examples, the icon glow is configured to various shapes, such as, but not limited to a splash, a star, bubbles, and a sun. The term “glow” as used herein, also incorporates pop-out design. The invention is not limited to the shapes or pictorial effects, and includes any other shapes or pictorial effects that may be pleasing to users or icon owners. Variation in different glow types will allow different icon owners, merchants, for example, to distinguish their brands and the “look and feel” of their icons.

In example embodiments the entire icon will glow, and in other embodiment only segments or portions of the icon will glow. For example, the left side of the icon may glow or the right side of the icon may glow. Such arrangements can represent different pieces or categories of information being communicated by the same icon. In another embodiment, the icon has pop-outs, that convey information. When the user clicks on the glowing icon, a larger box may appear showing information or further options. In another embodiment, the icon comprises a row of triangular shaped buttons.

The various glow types, such as graphic pictorial images, pop-outs and/or triangles, or any other elements, can be further combined in one icon in order to impart and communicate various categories of information to the user.

In an example embodiment hovering a finger, stylus or cursor over any of the icons may trigger a glow, indicating that a user can interact with it. Alternatively, an icon with an offer or other feature to communicate may glow automatically without the need for hovering over the display screen by the user.

As an example of one embodiment of the invention, a consumer is presented with certain information relating to a product offering sent by a particular merchant. The glowing of the icon represents information about a certain item, for example such as a shoe product, about which the user wishes to obtain particular information. The glowing itself can be in the form of little shoes depicted and emitting from the icon in order to indicate that information about the shoe product is to be communicated. The user can then click on the icon in order to obtain the relevant message. The message might include information such as the price or discount, location, timing and the availability or quantity of a particular shoe product. This will allow the user to purchase the product at the user's discretion while the advertised product or pricing is available.

According to the example embodiment, the on-page delivery of the interactive advertising and shopping occurs on a third party (“content provider”) site via interactive marketplace or marketbox windows that enable consumer to interact with the system, including purchasing without leaving the content provider's page. The on-page marketplace advertising may be arranged in a matrix or grid-like structure within a box or banner ad space located on a particular content provider webpage.

Consumers can be given an opportunity to set up an account and receive a personalized experience with the advertising. For example, a consumer may set up an account and specify the brands and advertisers that interest them, so they can receive special offers from those advertisers. In an example embodiment, the configuration of the matrix is a 60/40 split of the matrix between advertisers selected by the consumer (60%), and ads placed according to the consumer's demographic information (40%). The mobile application system displays a series of icons arranged in a grid-like arrangement, or matrix. In an example mobile application, the matrix displays between four and six icons, and depending on the mobile device they use, the users can scroll up and down the screen to view, for example twelve icons, or more. On the mobile device's main screen, each icon features the logo or similar symbol representing that company, brand, or advertiser. To learn more about that particular company, brand, or advertiser, the user taps or presses the icon either singularly or in a brief series, depending on which function they want to accomplish. Each icon provides a dynamic link to content relating to various companies, brands, and advertisers.

According to one embodiment, a system administrator will work with merchants advertising their products so that the merchant's logos appear in a matrix on the content provider's webpage and consumers/users of the content provider's webpage containing the on-page marketplace banner will organize the particular advertisers according to the consumer's preferences. The logos may be placed on a field that provides information through color, motion or sound indicating that there is an offer or opportunity to purchase.

In an example embodiment there are multiple components to the advertising system, including but not limited to: (1) Gamification or game “appification”—Engages users to interact with advertisers in a variety of game scenarios. Users can win rewards to apply to shopping or to share with friends. Gamification is a broad term which includes, but is not limited to, the interactive, back-and-forth communication between the consumer/user and online advertiser such that the user's interaction with the service is directed toward interaction, goals, strategies, and rewards. More goals and rewards are achieved with increased use, as is typical of many games (i.e. the process of “leveling up”); (2) Product Purchase—User buys a product through the website listing based on the advertiser's description and terms, without leaving the page; (3) Private Shopping Area—Isolated shopping with greater savings, discounts and offers. In an example embodiment, only users designated as VIPs can participate in the private shopping area. According to the example embodiment, users can obtain VIP status through the Membership component; (4) Corporate Pages—These are complete pages by an advertiser where it may display its goods. For example, an athletic goods advertiser may have all athletes, sports gear, athletic gear, shirts, shoes, pants or shoes in one area. The Corporate Page in this embodiment is contained within the advertising space on the content provider's website (5) Memberships—Users may obtain and manage the webpage of the example embodiment as basic members or as VIPs. These elements and components operate together to allow consumers to learn about and seize deals, build strong brand loyalties, and create a personalized shopping platform around their interests. This can all be done through the user's interaction with the disclosed method and system's novel dynamic icons and other features, which personalize the user's experience as interaction increases.

The basic level membership of the example embodiment provides free access to the online system. Users can freely navigate the matrix while on the content provider's website, which is the home base of the system's stand-alone site portion. Standard discounts, deals, offers, and sales can be found through the basic level using the matrix. Further, users can use the matrix to enter a marketplace within the space provided for the matrix on the third party content providers' websites incorporating the disclosed system. The disclosed method and system may also track users' choices, selections, and favorites, and compiles data about users' browsing preferences.

The second level of the example embodiment, the VIP level, provides select users with enhanced features. The user gets exclusive, private shopping e-mail address and contact information, as well as access to an exclusive product selection interface “dashboard.” VIP users have special access to specials, offers, and reserve bins, as well as the potential for greater discounts than basic users. The VIP level email address provides a central communication for purchase records, receipts, as well as shipping and tracking information from multiple vendors, to prevent such information from being lost and marked as “spam e-mail” on a different email system. This also provides an email address for the VIP level members to use without disclosing their personal email address. Basic users can upgrade to VIP level status through various payment options.

In an example embodiment, if the user is pre-registered with the system, payment for merchandise purchased through the disclosed advertising system may be paid for in separate exchange system of credits and debits. The exchange system can handle the payment directly, securely and privately and allow the user to easily track orders, payments, refunds and receipts. For example, in one embodiment when a user purchases an item using the advertising system, a browser window for the exchange system opens within the advertising system to handle the payment securely and privately without leaving the third-party content provider's webpage.

RETARGETING: The advertising system may be used by online marketing vendors who deliver retargeting services. Typically, “retargeting” involves directing advertising to a user based on a webpage or item the user has already viewed, and may also be based on keywords or location. Currently, systems exist which attach a cookie to the user's computer so that when that user visits a relevant site or searches relevant keywords, the cookie prompts the ad delivery server to deliver a prompt to nudge the user to take some action, e.g., purchase an item the user had previously viewed. The current advertising system can be used by online marketing vendors that deliver retargeting services in that the prompt or nudge delivered to the user by the online marketing vendor may be enhanced by using the dynamic icon and advertising system technology. For example, instead of delivering a typical passive advertisement, the cookie prompts the retargeting server to deliver a nudge in the form of a dynamic icon of the present system with a color trigger designating a special purchase opportunity for the user (for example, a purchasing outlet a short distance from the user, or a deal, or a change in price or a special offer, or other variables determined by the advertiser).

User behavior, patterns and demographics may be collected from users' interaction with the matrix and marketboxes, and this data is used to compile analytics (metrics) for use by advertisers and within the example advertising system to understand user interest, user engagement and purchasing behavior and direct targeted advertising of relevance to users. User data (but not identity or personal identification information) is licensed to advertisers for their own use, providing better targeting of advertising and offers to certain segments of the market. User data also is used to better target delivery of advertising and offers within the example advertising system.

The disclosed method and system may further include a voice activated application for use with mobile devices such as a smart phone and tablets. The voice recognition and activation component enables command searches. For example, the user asks the application via voice command for a particular advertiser, store, or other advertiser in the local area. The application will then identify what the user has asked for and display, on the mobile device's screen, the logo of the particular advertiser the user requested in his voice command. The user taps the logo and the mobile device speaks the address of the advertiser closest to the user and displays the address and other information about the advertiser, including relevant offers, deals or purchase opportunities. In one embodiment of the disclosed method and system, the logo is displayed on the mobile device's screen using the dynamic icon of the disclosed advertising system, with information and alerts about the advertiser communicated to the user by colors and color triggers (such as a glow), which information might include proximity to the user, “trust meter” rating, availability of relevant offers, deals or purchase opportunities, whether that advertiser at that location is at that time open or closed, or other information relevant to the user. Another tap on the logo reverts to a program, possibly using an API (application programming interface) provided by a third party company that provides directions and maps to the advertiser, store, or manufacturer's location.

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 shows a display screen showing the example embodiment's icon matrix.

FIG. 2 shows a larger, breakout box of a particular icon as selected by the user.

FIG. 3 shows the breakout box of FIG. 2 with the Specials icon highlighted.

FIG. 4 shows the breakout box of FIG. 2 after the user has selected the Specials icon.

FIG. 5 shows the breakout box of FIG. 2 with the Hot Product icon highlighted.

FIG. 6 shows the breakout box of FIG. 2 with the Close Out icon highlighted.

FIG. 7 shows the breakout box of FIG. 2 with the additional branch out menu that appears after the user has selected the Close Out icon.

FIG. 8 shows the breakout box of FIG. 2 with additional products displayed when the user has selected the Close Out icon.

FIG. 9 shows the breakout box of FIG. 8 with extra details of the selected product displayed when the user has selected that product.

FIG. 10 shows the breakout box of FIG. 9 with an additional info box that has slid out to the right of that breakout box.

FIG. 11 shows the breakout box of FIG. 2 after the user has selected the Instant Buy icon.

FIG. 12 shows the breakout box of FIG. 11 with the Trust Meter pop-out box on the left side of the breakout box.

FIG. 13 shows the breakout box of FIG. 12 with the Distance Meter pop-out box on the right side of the breakout box.

FIG. 14 shows a graphical depiction of the matrix as it appears on a mobile device in conjunction with the Visual Voice platform.

FIG. 15 shows a graphical depiction of the algorithms used to institute the Visual Voice platform.

### DETAILED DESCRIPTION OF THE PREFERRED EMBODIMENT

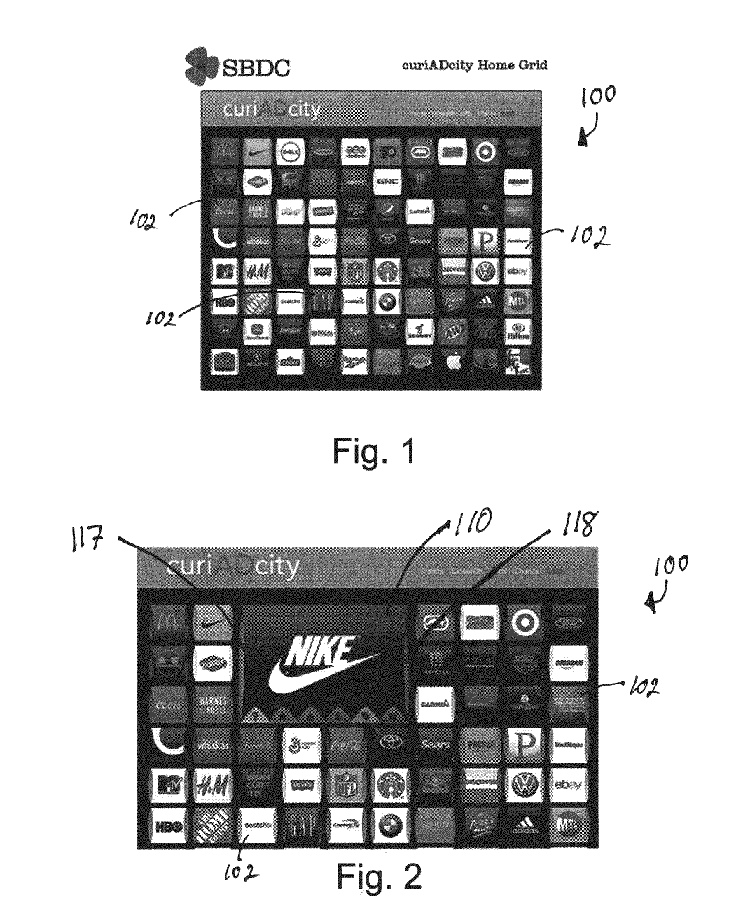

The following detailed description and the drawings FIGS. 1 through 13 are of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Referring now to FIG. 1 in which the system's home screen is shown. This home screen is the on-page advertising icon banner matrix 100 of the example embodiment. The matrix may be hosted within defined advertising space on a webpage of a content provider. The example embodiment shown in FIG. 1 shows the icons of various merchants arranged in ten columns and eight rows. Hovering a cursor over any of the icons 102 may trigger a glow, sparkle or other movement/light (herein all called “glow”), indicating that a user can interact with it. Alternatively, an icon with an offer or other feature to communicate may glow without a user hovering. Once the consumer clicks on the glowing icon, they will see a larger box with more options as seen in FIG. 2.

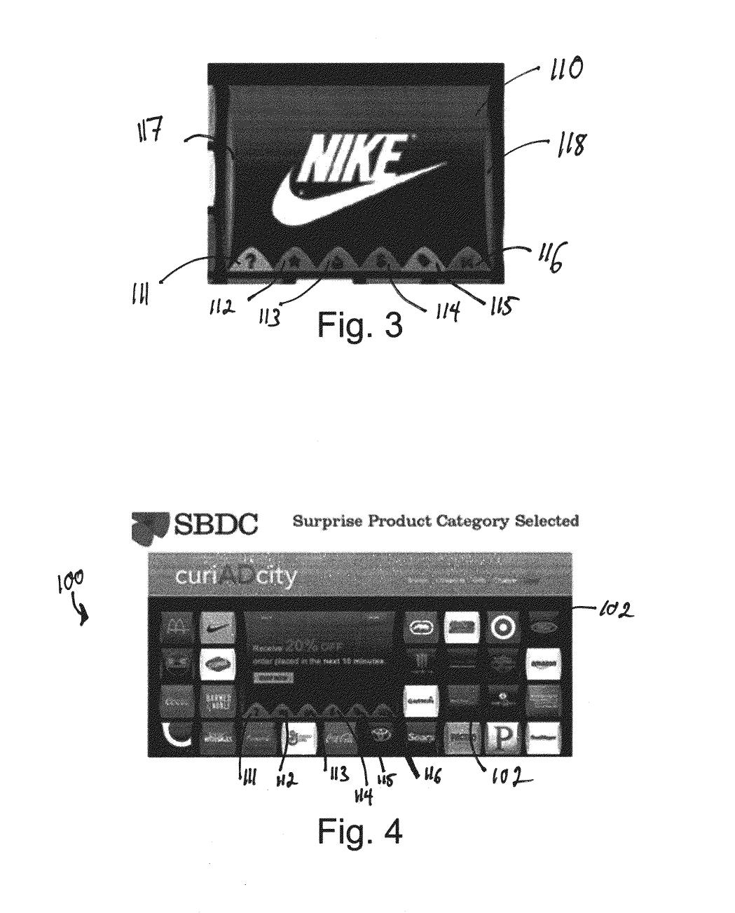

As seen in FIG. 2 and best seen in FIG. 3, this larger box is referred to as the marketbox 110 and provides the user with six of its own icons that can be interacted with, each of the six representing a different category: Surprise 111 (Question Mark), Special 112 (Star), Hot Product 113 (Fire Symbol), Close Outs 114 (Dollar Sign), Product Category 115 (Price Tag), or Instant Buy 116 (Shopping Cart). These categories are sometimes referred to herein by the abbreviations SP (Surprise Purchase), HP (Hot Product), CO (Close Out), PC (Product Category, and IB (Instant Buy).

Further, as seen in FIG. 3, the sides 117 and 118 of the marketbox 110 each may glow a different color. The color is communicating something useful to the user. As shown in FIG. 2, the yellow on the left side 117 of the marketbox 110 indicates that advertiser's trustworthiness via Trust Meter and the blue or green or yellow or red on the right side 118 brings up that vendor's location from the user via the Distance Meter.

Surprise 111, the category identified by the question mark icon, may be clicked by the user to find an advertiser defined-surprise that they may buy. Reasons for Surprises may include, but are not limited to testing of new products; seasonal clearance; automatic rotation of advertiser products; damaged items; refurbished items or limited quantity. When creating Surprises, the advertiser has the ability to choose demographics, regions, number of items sold; day of the week/time limit, automatic rotation of advertiser products, price, and other factors.

Referring now to FIG. 4, in this example embodiment, Specials 112, the second category, applies exclusively to VIP members. Specials 112 can be a single item or a group of items as determined by the advertiser. Examples could be a type of shoe, or all shoes. If a basic member (i.e. non-VIP consumer) clicks on Special 112 or Instant Buy 116, the icon will rotate and lead to a breakout box that describes the benefits and special pricing for VIPs and a link to obtain VIP status. Rules for Specials 112 and Instant Buys 116 may include: 1) Only users with VIP status will have access to see what's available in the Specials category; Non-VIP users are taken to a benefits/sign up page if they click on the Specials icon. 2) VIP members have access to three levels of the wish list function including placing an item on hold for up to 24 hours at the Special price. 3) VIP members also have the ability to share the special for up to 6 hours via email and social media.

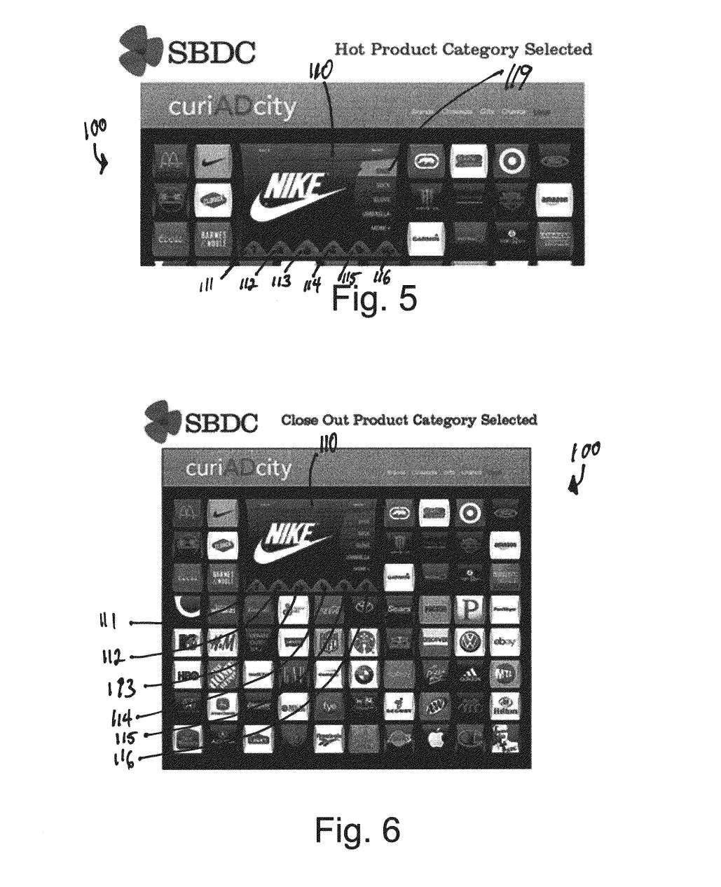

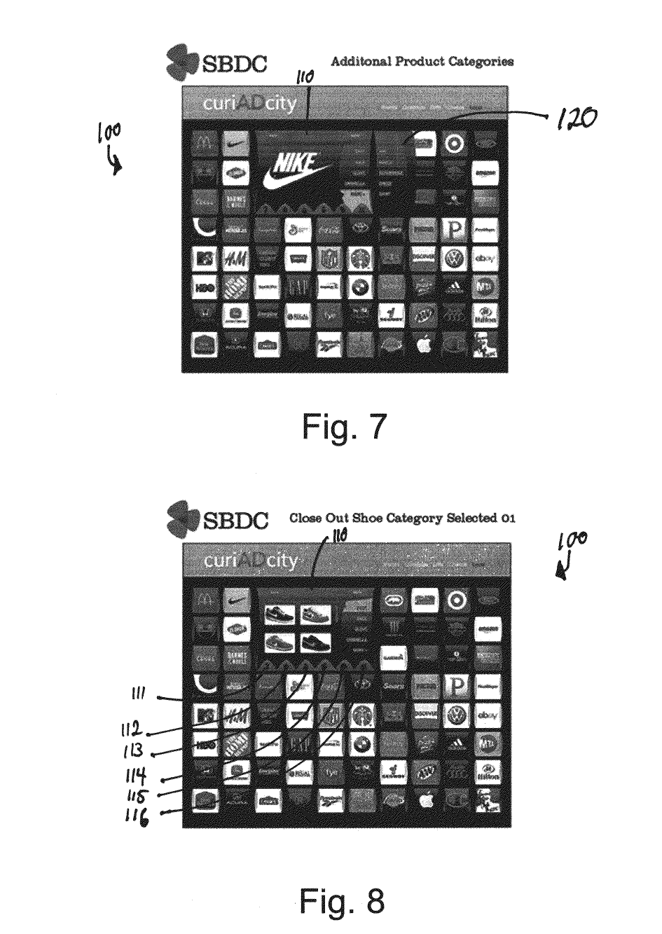

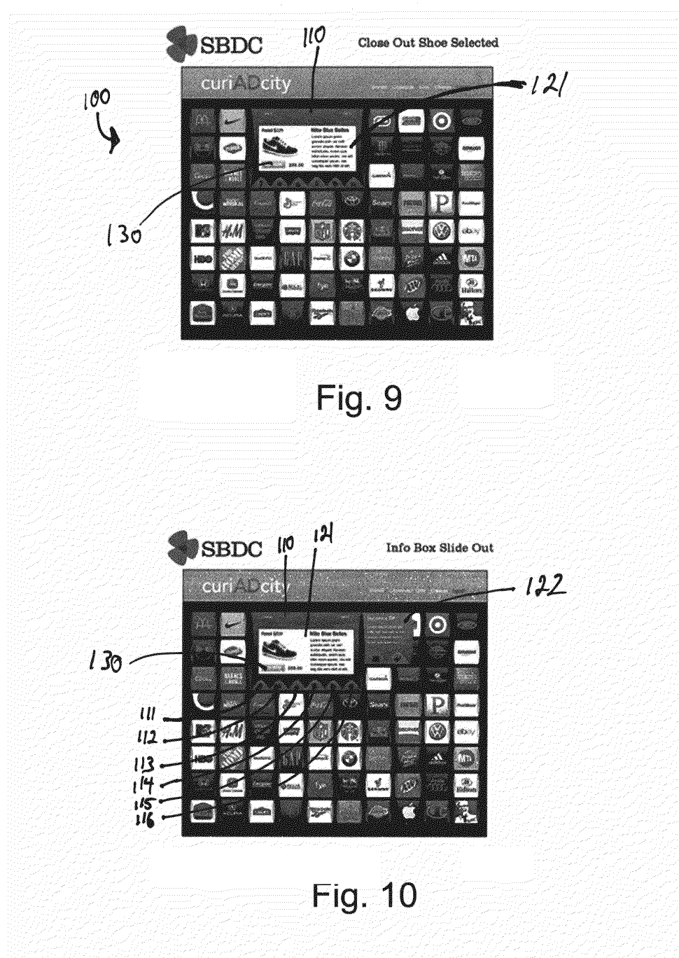

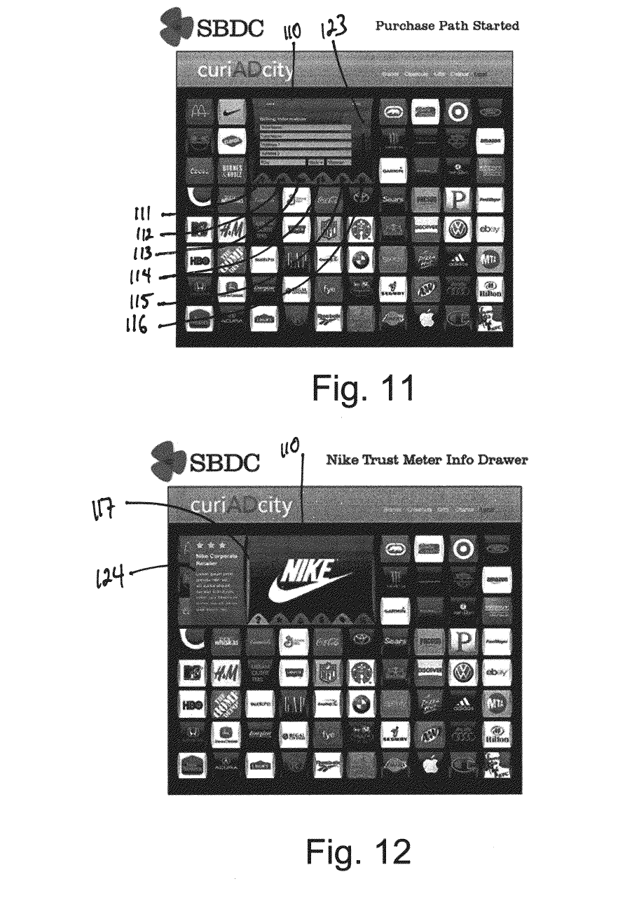

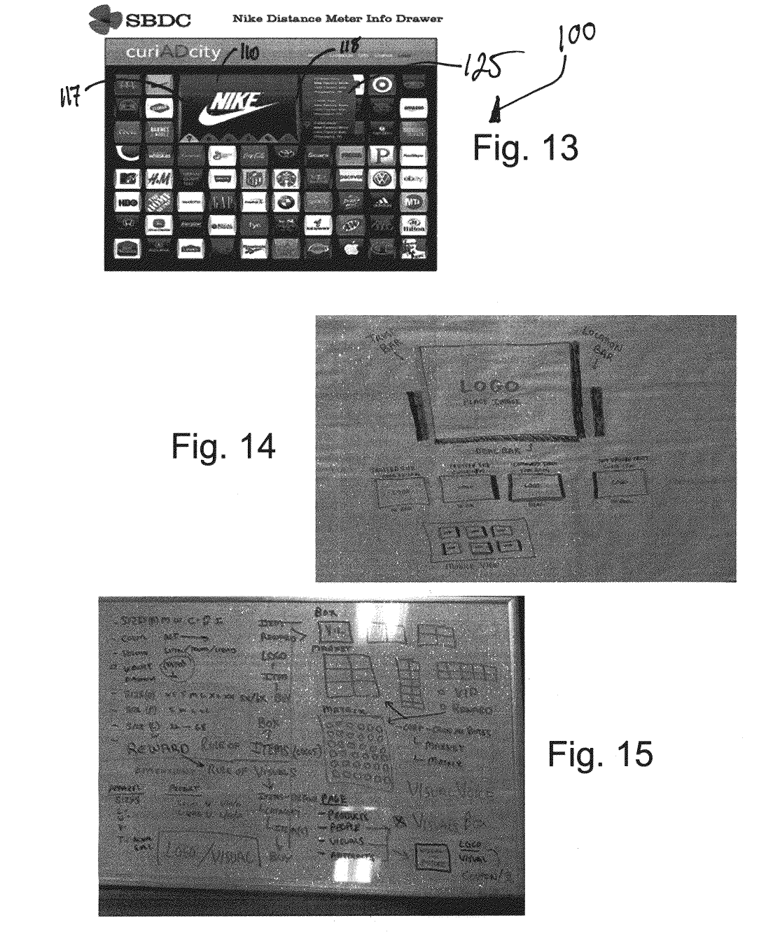

Referring now to FIG. 5, the third category, Hot Product 113, identified by the Fire Symbol, may be a single item determined by the advertiser. FIG. 5 depicts “shoe” 119 as the product about which the user wishes to get more information. Hot Products 113 may include new products, seasonal products, timely products and products that are in the news, and limited quantity products. FIG. 6 depicts the next category: Close Outs 114. Close Outs 114 can be a single item or a group or items determined by the advertiser. In the example embodiment items that are offered for purchase under the Close Outs 114 category are liquidation items that are highly discounted. The Close Outs 114 icon can branch out into an additional menu 120 with more product categories as seen in FIG. 7. If the consumer wants to see certain products that are in the Close Out 114 category; for example, a shoe, he will click the word “shoe” on the branch out menu and four shoes will display. As seen in FIG. 8, advertisers can define which Close Out 114 products (in this example, shoes) they want to display. While the consumer is reviewing the four shoes, the screen may switch to even more deals for close out shoes, if necessary, and provide the consumer with the possibility of visiting the website, or a version of the merchant's website within the marketbox 110. Once a user selects a shoe, the screen will provide more detailed information 121 as seen in FIG. 9. For example, the screen may provide information about the product, such as a shoe, a price, and a Buy Now button 130 to purchase the product. Further, as seen in FIG. 10, another pop-out info box 122 can slide out on the right of the marketbox 110, which provides the user with the option of becoming a VIP member. For example, a user may click on an Instant Buy button 130 to purchase shoes at a discount, and is then given the offer to receive a larger discount if they become a VIP member before purchasing the shoes. When the user clicks the Instant Buy button 130 in the example embodiment, the screen provides a purchase path for the user to follow as seen in FIG. 11. If the member is a VIP they will have the option to click another button that brings up a wish list when clicked. The Instant Buy 116 menus may also include a Trust Meter 123. The Trust Meter provides proof of the advertiser's and/or product's trustworthiness as gathered by reviews and ratings and related social media. Reviews and ratings may be an important part of the shopping experience. In an example embodiment consumers will be able to see indicators of trustworthiness within the matrix and on the marketplace window. In another embodiment, the Trust Meter is indicated by a yellow glow on the left side 117 of the breakout box as seen in FIG. 2. The left side 117 of the marketbox 110 alternates shades of yellow colors to appear as if it were glowing and to call attention to itself. When the consumer clicks it, an “info drawer” 124 opens on the left side, i.e. a pop-out with information including ratings and reviews pops out on the left side as seen in FIG. 12. The reviews and rating system in the info drawer 124 can be scrollable so that more information may be provided. The Instant Buy 116 menus also include a Distance Meter. The Distance Meter is indicated by a blue/green glow on the right side 118 of the marketbox 110 as seen in FIG. 2. The right side 118 may alternate shades of blue/green to appear as if it were glowing and to call attention to itself. When the consumer clicks the right side 118, an “info drawer” 125 opens on that side, i.e. a pop-out with information including distances and locations of the relevant products as seen in FIG. 13.

Referring now to FIG. 14, a diagram of an example embodiment of the dynamic icon of the advertising system is shown. In this example embodiment, a location bar, a trust bar and a deal bar are shown, with the appearance and color of each bar indicating information relating to that bar. FIG. 14 also shows an example embodiment of a mobile device screen showing a matrix of six dynamic icons of the advertising system, each conveying different information about the advertiser correlating to that dynamic icon as shown by its logo (the logos not shown on this diagram). For example, as shown in the row of dynamic icons, the first icon shows the dynamic icon of the invention indicating that the advertiser is trusted (yellow trust bar on left) and is nearby, for example between 0.5 miles and 1 mile away (yellow location bar on right) but has no deal (absence of deal bar on bottom). The second dynamic icon indicates that the advertiser is trusted (yellow trust bar on left) and is slightly further away, for example, e.g., 1.5 miles away (green location bar on right) but has no deal (absence of deal bar on bottom).

Referring now to FIG. 15, a graphical depiction of the algorithms used to institute the Visual Voice and other embodiments is shown. In the example embodiment outlined in FIG. 15, example options are shown which may be necessary for a consumer to decide when making a purchase, for example, a consumer who is purchasing clothing may need to decide between sizes, material types such as cotton, wool or synthetics, style such as a collar or trim style, and color. In another example a consumer may be purchasing food products such as chocolate, and will need to decide on various offerings, as well as size, and quantity. Some or all of these choices may be presented by using logos or visual choices.

If products are going to be shipped, determinations of shipping costs and whether multiple items can be shipped together will need to be made in determining a final price. The final determination of price may also depend on the rewards earned through interactions with the system or through purchase of VIP status.

The right side of FIG. 15 shows example marketboxes with different configurations to match different sizes of advertising spaces on web sites. As shown, a matrix in this example embodiment may show one logo, two logos, four logos, six logos, ten logos, twelve logos, thirty six logos.

Various pages may be presented through the example embodiment of FIG. 15, including but not limited to pages showing products, pages showing people, pages showing visuals, and pages showing abstracts.

Various changes may be made which are not shown in the drawings of the example embodiments, but which may be within the scope of the claims. For example, the icons 102 are arranged in rows and columns in the example embodiments. Other arrangements of icons may also be used such as circles, triangles, hub and spoke, random placement, within an area, partially overlapping or other methods of placement.

Additionally, the marketbox 110 is shown as occupying a portion of the matrix 100, specifically, the marketbox 110 is shown occupying the space of twelve icons in four columns and three rows. The marketbox 110 in other embodiments may occupy more or less space in the matrix 100, and may occupy the entire space in the matrix 100. The example embodiments only show one marketbox 100 open, but in other examples multiple marketboxes 110 may be opened at the same time to compare multiple offers, or to preserve multiple offerings before they expire.

The example embodiments also show all of the icons 102 as the same size, and with only one icon 102 for each unique merchant. In other embodiments merchants may have more than one icon occupied in a matrix, or may have a larger icon than other icons in the matrix.

The example embodiments show and discuss symbols for the display of information regarding different categories. In other embodiments different symbols, or words, letters, or abbreviations may be used instead of pictures or symbols to indicate different categories. Further different categories than those discussed above may be used, and the example embodiments do not limit the number or type of categories.

The example embodiments disclosed the use of color on the sides of icons 102 to indicate information about the offer or location of the merchant. The colors discussed were by way of example and different colors may be used. In other embodiments other visual indicators may be used to communicate information about a merchant. For example one of the icons 102 may be shown issuing bubbles, smoke or sparks or other visual effect to indicate an offer is available. In other embodiments sound or vibration may also be used to indicate an offer is available, for example a mobile device with the ability to vibrate may use a vibration to indicate a deal is available.

The marketboxes 110 are shown in the example embodiments with visual indicators of ranking and distance for a merchant on the sides of the marketbox 110. In other embodiments other indicators may be used in other locations. For example, background colors or images, may be used to indicate ranking or other information about the merchant. The example embodiment includes colors shown on the sides of the marketbox 110, but visual indicators may be placed at the top or bottom or other locations to communicate information about the merchant.

On a mobile device, the matrix of the example embodiment may be smaller and may incorporate fewer interactive icons than that of the standard matrix depicted in FIG. 1, being limited by practical size considerations of the display screen. Though the mobile device application of the example embodiment may display a smaller number of icons, it may still provide a large breakout box (marketbox) similar to that demonstrated in FIG. 2.

What is claimed is:

1. A method of advertising comprising the steps of:
providing multiple icons from multiple merchants within a defined advertising space on a webpage, wherein each of the multiple icons corresponds to one of the multiple merchants; and
responding to a user's selection of one of the multiple icons by displaying an offer to purchase goods or services from one of the multiple merchants, wherein the displaying the offer is performed within the defined advertising space on the webpage.

2. The method according to claim 1, further comprising the step of collecting payment information within the defined advertising space on the webpage.

3. The method according to claim 1 further comprising the step of communicating information about at least one of the multiple merchants by adjusting visual aspects of at least one of the multiple icons.

4. The method according to claim 3, wherein the step of communicating information is performed by changing a color to indicate distance to the at least one of the multiple merchants.

5. The method according to claim 3, wherein the step of communicating information is performed by changing a color to indicate a rating of the at least one of the multiple merchants.

6. The method according to claim 2 wherein the step of collecting payment information includes using an online payment system that allows for transfer of credits and debits electronically.

7. The method according to claim 1 wherein the step of providing multiple icons further comprises providing the multiple icons aligned in rows and columns.

8. The method according to claim 1 further comprising the step of hosting an email account for the user wherein purchasing and shipping information from purchases made from the offer to purchase are sent to the email account.

9. The method according to claim 1 further comprising the step of tracking the user with a tracking cookie, wherein the offer to purchase goods or services is displayed according to information from the tracking cooking.

10. The method according to claim 1 further comprising the step of tracking the user's interactions with the multiple icons and adjusting the multiple icons based on the user's interactions.

11. The method according to claim 1 wherein the step of responding to a user's selection includes providing information regarding liquidation sale items.

12. The method according to claim 1 wherein the step of responding to a user's selection includes providing information regarding products offered from a merchant corresponding to the user's selection of the one of the multiple icons.
